(19) United States
(12) Patent Application Publication
(10) Pub. No.: US 2025/0055107 A1
(43) Pub. Date: Feb. 13, 2025

(54) COMPOSITE BATTERY ENCLOSURES HAVING EXTERIOR IMPACT COMPONENTS

(71) Applicant: BRIDGESTONE AMERICAS,INC., Nashville, TN (US)

(72) Inventors: Mark W. Brandley, Nashville, TN (US); Denis Schmitz, Munchen (DE); Inigo Echeto, Munchen (DE); Markus Freiberger, Munchen (DE); Adam J. Halsband, Munchen (DE)

(21) Appl. No.: 18/721,745

(22) PCT Filed: Dec. 14, 2022
(86) PCT No.: PCT/US2022/081520

§ 371 Date: Jun. 19, 2024

Related U.S. Application Data
(60) Provisional application No. 63/292,550, filed on Dec. 22, 2021.

(51) Int. Cl. H01M 50/242; H01M 50/209; H01M 50/231

(52) U.S. Cl. CPC H01M 50/242; H01M 50/209; H01M 50/231; H01M 2220/20

(57) ABSTRACT

A battery enclosure formed by a protective shell of multiple components secured to one another to house a battery storage area are protected from damage by attachment of an impact barrier to deflect and absorb damaging forces encountered by the enclosure. The impact barrier includes a deflection section spaced apart from the outer surface of the battery enclosure to permit deformation of the deflection section. The deflection section further provides an open space for engaging a service access component of the protective shell for gaining entrance to the battery storage area or disassembling the battery enclosure.

### TECHNICAL FIELD

The present disclosure relates to modular structural composites for use as battery enclosures and, in particular, to structural composites having an exterior impact component for use as a protection barrier.

### BACKGROUND

Vehicles powered by electric batteries have grown in popularity with users. These vehicles allow a user the ability to charge the batteries at their place of residence or at a charging station and avoid the cost of purchasing gasoline. To supply the power needed to reach long distances, these vehicles need large capacity batteries. However, these large capacity batteries pose an increased risk to occupants and emergency responders if the batteries are damaged during a collision. The batteries need to be protected from the force generated during the collision or alternatively, any force transmitted to the batteries must be low enough so as not to cause significant damage to the batteries.

The present disclosure provides battery enclosures that are strong and light weight, as compared to battery enclosures known previously. The enclosures utilize composite materials, optionally with exterior impact components and features, to protect the batteries from significant damage during a collision and assist in the assembly of the enclosures during manufacturing. The exterior impact components provide an initial deflection or absorption for improved crash performance while also allowing access to the battery enclosure attachments to permit service of the interior batteries and related equipment.

### SUMMARY

In a first aspect, disclosed is a battery enclosure, for example a composite battery enclosure, that includes an outer surface that forms the perimeter shell of the enclosure, the outer surface is formed, at least in part, of a first cover component and a second cover component that make up an exterior portion of the outer surface of the battery enclosure, and the enclosure further includes an impact barrier positioned on the outer surface of the battery enclosure, the impact barrier having a deflection section arranged away from or spaced apart from the outer surface of the battery enclosure.

In another example of aspect 1, the deflection section of the impact barrier forms an open area between the outer surface of the battery enclosure and the exterior surface of the deflection section such that an attachment point is accessible in the open area to disassemble or gain access to the battery storage area of the battery enclosure, for instance, to perform maintenance.

In a second aspect, there is a battery enclosure that includes a protective shell having an outer exterior surface, the protective shell defining in part a battery storage space inside its outer exterior surface, and a service access component arranged on the outer exterior surface of the protective shell for permitting access to the battery storage space inside the protective shell, and the enclosure further includes an impact barrier secured to the protective shell, the impact barrier having a deflection section spaced apart from the outer surface of the protective shell.

In another example of aspect 2, the service access component is positioned in an open area formed between the outer surface of the protective shell and a surface of the deflection section of the impact barrier such that the service access component is accessible through the open area for entry into the battery storage area or related compartment.

Any one of the above aspects (or examples of those aspects) may be provided alone or in combination with any one or more of the examples of that aspect discussed above; e.g., the first aspect may be provided alone or in combination with any one or more of the examples of the first aspect discussed above; and the second aspect may be provided alone or in combination with any one or more of the examples of the second aspect discussed above; and so-forth.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments. Directional terms as used herein—for example, up, down, right, left, front, back, top, bottom—are made only with reference to the figures as drawn and are not intended to imply absolute orientation.

### BRIEF DESCRIPTION OF THE DRAWINGS

The above and other features, examples and advantages of aspects or examples of the present disclosure are better understood when the following detailed description is read with reference to the accompanying drawings, in which:

FIG. 1 shows a cross-section view of a two-piece battery enclosure including a molded upper composite cover and a molded bottom composite cover with a battery storage area.

FIG. 2 shows a cross-section view of a portion of the two-piece battery enclosure of FIG. 1 having the molded upper composite cover secured to the molded bottom composite cover at an attachment point along an outer surface of the battery enclosure.

FIG. 3 shows a cross-section view of a portion of composite battery enclosure having an impact barrier attached to its outer surface and the impact barrier having a deflection section spaced apart from the outer surface of the enclosure to form an open area for accessing an attachment point or similar component on the battery enclosure.

FIG. 4 shows a cross-section view of the partial composite battery enclosure of FIG. 3 having the deflection section bent or deformed by an impact, external force, such that the deflection section is bent and contacts the outer surface of the battery enclosure.

FIG. 5 shows a cross-section view of a portion of composite battery enclosure having an impact barrier attached to its outer surface and the impact barrier having a deflection section spaced apart from the outer surface of the enclosure to form an open area for accessing an attachment point or similar component on the battery enclosure.

FIG. 6 shows a cross-section view of a portion of composite battery enclosure having two impact barriers attached to its outer surface, at an upper and bottom composite cover, and the impact barriers each having a deflection section spaced apart from the outer surface of the enclosure to form multiple open areas for accessing an attachment point or similar component on the battery enclosure.

### DETAILED DESCRIPTION

The terminology as set forth herein is for description of the embodiments only and should not be construed as limiting the invention as a whole. Herein, when a range such as 5-25 (or 5 to 25) is given, this means preferably at least or more than 5 and, separately and independently, preferably less than or not more than 25. In an example, such a range defines independently 5 or more, and separately and independently, 25 or less.

The terms “substantial,” “substantially,” and variations thereof as used herein are intended to note that a described feature is equal or approximately equal to a value or description. For example, a “substantially planar” surface is intended to denote a surface that is planar or approximately planar. It also is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

The present disclosure relates to battery enclosures, such as composite battery boxes, that can be used in a variety of applications. For example, the battery enclosures can be used to house battery systems and related accessories for mechanical equipment and in automotive applications (e.g., passenger vehicle, car, truck, bus, tractor, all-terrain vehicle). In some embodiments, the battery enclosure can house in a storage area a battery system for electric and hybrid vehicles. In some examples, the battery enclosure can be modular and be formed from multiple pieces or components connected or attached to one another, at attachment points, to form a complete enclosure, box or shell having an exterior outer surface, for instance, in the form of a protective shell defining an interior battery storage area or plurality of compartments.

The battery enclosures can generally have increased global stiffness that resists bending and torsion of the structure and are relatively lightweight. In one or more embodiments, the composite battery enclosures can have connection or attachment points between the top and bottom covers to secure the covers together and provide crash strength and integrity. Easy access to the connection points is desirable to perform maintenance on the battery enclosure and equipment contained inside, such as batteries and related electronics in the battery storage area. In other embodiments, the covers or the like can be a protective shell that forms an outer surface of the battery enclosure. The protective shell can be a composite material used to house an internal storage area or plurality of compartments for containing batteries and other related components such as wiring, cooling features, sensors, etc. The protective shell, or one or more covers, can have a service access component arranged on the outer surface of the battery enclosure for accessing one or more areas or compartments in the battery enclosure. For example, the service access component can be mechanical fastener or latch for opening a panel or portion of the outer surface to permit entrance into an internal storage area of the battery enclosure.

During the operating life of the battery enclosure and the components that reside inside, maintenance is required that includes working on or checking equipment housed in the enclosure. Design features that are arranged on the outer surface of the battery enclosure, such as connection points or service access components, need to be accessible and the present battery enclosures include one or more impact barriers that accommodate or are capable of providing a user to engage a connection point or service access component. The impact barrier is positioned on an outer surface of the battery enclosure, for example, on a cover or protection shell, to provide improved crash performance and offer protection from an impact or collision. That is, the force from a collision is applied first to the impact barrier that can deflect and/or absorb the force or part of the force before it is potentially transferred to and encountered by the battery enclosure.

The impact barrier has a deflection section that is designed to provide an open entry point for a user to engage a connection point or service access component on the outer surface of the battery enclosure. The deflection section can be designed to cantilever from a base section of the barrier such that the cantilevered section is positioned away from the outer surface of the battery enclosure to form an opening between outer surface of the battery enclosure and the deflection section that is further open to the surrounding environment. The opening provided between the deflection section of the impact barrier and the outer surface of the battery enclosure permits a user to easily contact the connection point or service access component for opening the battery enclosure to perform needed maintenance or inspection tasks. For example, a user can insert a tool or similar device into the open area to interact with the connection point or service access component for opening the battery enclosure.

In one or more embodiments, the impact barrier can be primarily or substantially hollow to minimally contribute to the overall weight of the battery enclosure without reducing the rigidity of the overall structure. The impact barrier, noted above, is further equipped with a deflection section that is spaced apart from the outer surface of a battery cover or shell to provide a section that can more easily bend and deform when encountering a collision force. The deflection section can also be primarily hollow or contain a plurality of open cells or hollow through passages to reduce weight and also promote bending or detachment from the remaining portion of the impact barrier. In one or more embodiments, the deflection section will partially detach from a base portion of the barrier and interface with the outer surface of the battery enclosure to provide distributing impact forces on selective sections of the battery enclosure, for example, an upper or lower section of the enclosure.

In other embodiments, the battery enclosure can have two or more impact barriers arranged on its outer surface to provide additional protection of multiple areas of potential impact with a collision force or related crash contact. For instance, impact barriers can be positioned around the exterior perimeter of the battery enclosure in areas having a high frequency or incidence of impact with a foreign object. Multiple impact barriers can be arranged around a single connection point or service access component to ensure routing access for disassembling the battery enclosure is available.

As described herein, the battery enclosures can be formed from composite materials, however, this is only one example of a material that can be utilized. When using composite materials, the battery enclosures can have a cover with a multi-thickness composite structure attributing to improved assembly of the enclosure and increased lateral stiffness of the enclosure in combination with accommodating the attachment of one or more impact barriers on the outer surface of the enclosure. Other advantages of the composite battery enclosure and impact barriers are the components being easily formable into a desirable shape by conventional methods, such as extrusion, pultrusion, or molding methods, e.g., that preferably use low or moderate pressure and heat, which advantageously lowers time and cost to manufacture the structures.

The individual components, for instance battery enclosure components and impact barriers, even if made from different materials, can be attached to one another by conventional methods, for example, using an adhesive or epoxy, a fastener (e.g., screw, bolt, clip), welding, a sealing material, or a combination thereof. For a chemical bond or attachment means between components of the battery enclosure and/or impact barrier, any suitable adhesive can be used, for example, an epoxy. The adhesive can be applied to an outer surface of a composite cover, such as an exposed surface of fiber layer or an outer perimeter flange section, and an attachment surface of the impact barrier designed to contact or engage with the outer surface of the battery enclosure. It is preferable that the components of the battery enclosure are permanently attached to one another and the impact barrier to ensure structural integrity of the battery enclosure or modular structure during use. Other fasteners or attachment fixtures can be used in place of an adhesive, for example, a screw, snap fitting, rivet, clamp, bolt or clip. Additional local inserts or onserts can be provided at attachment locations to provide increased stiffness beyond that provided by the improved connection points of the top and bottom covers of the battery enclosure, which are also preferably accessible through the open area formed between the deflection section of the impact barrier and the outer surface of the battery enclosure.

The individual composite structures of the battery enclosure, such as a molded bottom and top composite cover, can have similar components that can be made of the same or similar materials. For example, the composite covers can have a fiber-containing layer at least partially adhered to a core structure or material, which can optionally have a select multi-thickness or regions therein, for example, at or near the connection point between the covers. The fiber layers of various individual composite covers can be made of the same or similar materials to reduce material and manufacturing costs. Similarly, when recycled materials can be substituted, for example, for fibers in the fiber layers, such materials can be used to further reduce manufacturing costs and promote sustainability.

The one or more impact barriers can also be made from several methods and be prepared form similar components, or combination of components. For example, the impact barrier can be made from a metal, such as carbon steel, aluminum, an alloy, stainless steel, or carbon fiber, fiber glass, aramid, nylon, polyester, PET, PEN, or any combination thereof. The impact barrier can have any desired shape and includes at least a base portion that has a surface for contacting and/or attaching to the outer surface of the battery enclosure or an attachment device arranged thereon. The impact barrier can also include a deflection section, which, in some examples, can be in contact or extend from the base portion or section of the barrier. The deflection section is designed to cover or surround a portion of the outer surface of the battery enclosure but not be, either entirely or a portion thereof, directly in contact with the outer surface. The portion of the deflection section spaced apart from the outer surface of the battery enclosure permits the deflection section to flex, bend, tear, detach or otherwise deform or be damaged before any impact force is exerted onto and transferred to the outer surface of the battery enclosure.

One or more embodiments further include methods for fabricating and manufacturing individual and modular composite battery enclosures and impact barriers. For example, an impact barrier can be positioned or applied on an outer surface or multiple surfaces of a cover or protective shell (e.g., a first surface) to form a modular structure. Attachment devices or adhesives can optionally be positioned and used to secure the impact barrier to the battery enclosure, for example, a curable material (e.g., resin) can be sprayed, poured, spread, rolled, brushed or calendared onto the outer surface or a surface of the impact barrier to form an attachment means. Under heated conditions, the structure components can be molded (e.g., in a compression or press mold or similar tooling) or pressed together to form a final shape of the battery enclosure or simply curing the one or more adhesives to rigidly secure the impact barrier to the outer surface of the battery enclosure.

Molding or bonding conditions, if used with the impact barrier and/or components of the battery enclosure, such as temperature and pressure, can be adjusted as needed but are preferably low to moderate to reduce time and cost of manufacturing the desired structure. For example, the enclosure can be heated during molding or bonding to a temperature in the range of about 100° to about 200° C., about 110° to about 190° C., about 120° to about 180° C., or about 130° to about 160° C. In another example, the enclosure can be subjected to pressure during molding in a range of about 0.1 megapascal (MPa) to about 1 MPa, about 0.15 to about 0.8 MPa, or about 0.2 to about 0.6 MPa.

Before securing the impact barrier to the outer surface of the battery enclosure, the enclosure surface (e.g., covers, protective shell) can be cleaned to remove debris or any excess material from the surface. Cleaning can be carried out with conventional methods, for example, pressurized gas or air can be blown on the composite covers to dislodge debris, such as dust or particles, that is adhered to the surface. The battery enclosure can also be brushed or wiped to remove unwanted material. In another example, the enclosure can be brought into contact with a cleaning solution, which can dissolve residue (e.g., release agents) from the surface. For instance, an aqueous solution with a cleaning agent (e.g., a surfactant) can be used. A cleaning solution can applied to the surface of the enclosure by any suitable method such as spraying, dipping or brushing before securing the impact barrier. In some embodiments, the battery enclosure can have additional coatings applied to its surface, such as an overcoat or protective coating (a fire, smoke and toxicity (FST) material, fire-retardant material or resin), which can underlie or be applied around an impact barrier. In other embodiments, the composite battery enclosure can be painted for its final application, inclusive of any impact barrier adhered to its surface, for example, for installation in an electric or hybrid vehicle.

In one or more embodiments, assembly of the battery enclosure and related components can be carried out by positioning the bottom cover and then inserting the desired battery system. Battery cells can be mounted over a cooling system, if present, followed by connection of all electrical cables. If desired, a perimeter seal is positioned on the bottom cover before placing the top cover over the bottom cover. Attachment means, for instance adhesive or fixtures (e.g., screws) at a connection point or service access component, are used to secure the top and bottom covers tightly together before attaching the one or more impact barriers, for example along a perimeter edge, and mounting the assembled battery enclosure in the desired application such as an electric vehicle.

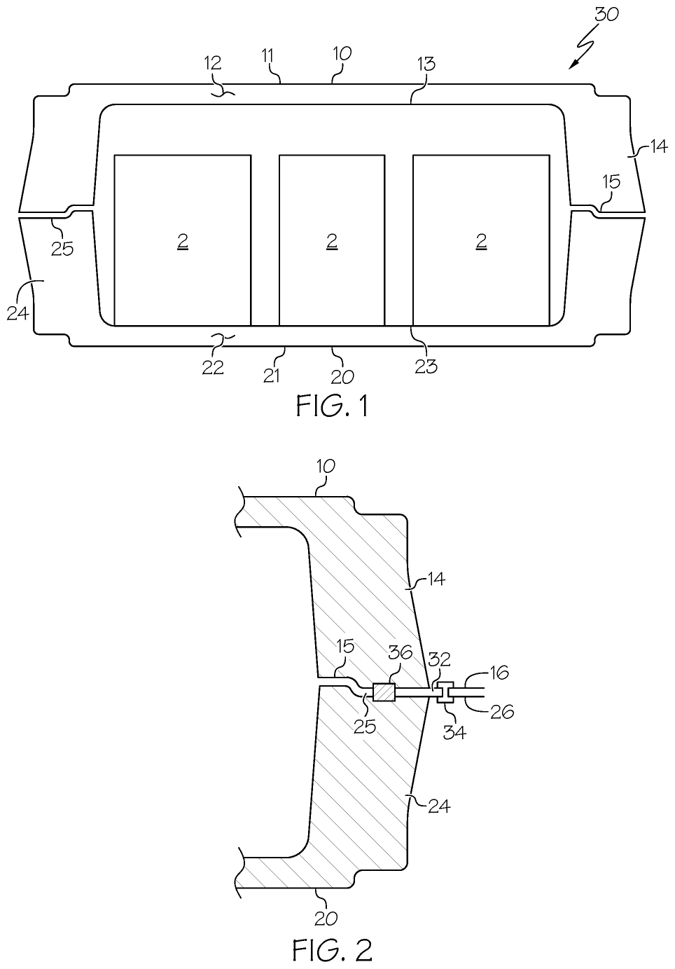

Turning to the figures, FIGS. 1 and 2 show a composite battery enclosure 30 that includes a top cover or cover component 10 and a bottom cover or cover component 20. The top and bottom covers 10, 20, as shown, are formed by core material sandwiched between cover skins, of which some cover skins form the outer surface of the battery enclosure. The top composite cover 10 has core material 12 sandwiched between top skin 11 and bottom skin 13 such that the core material directly contacts the skins and top skin 11 forms the upper half of the outer surface of the battery enclosure. Bottom composite cover 20 has a top skin 21 and a bottom skin 23, which sandwiched core material 22 is positioned therebetween and is in direct contact with the skins and top skin 21 forms the lower half of the outer surface of the battery enclosure. In one or more embodiments, the skins 11, 13, 21, 23 can be a fiber layer, which can contain continuous and/or discontinuous fibers embedded in a polymer material (e.g., parallel, angled, perpendicular, random patterns) to form layers having a substantially uniform thickness. The fibers can be arranged together to form a sheet or mat that can be positioned on a core material. Examples of fibers that can be used in the fiber layer include carbon fibers, glass fibers, plastic fibers, etc.

A polymer forming material or resin can be applied onto the fibers. The polymer forming material can penetrate and soak into the fibers arranged on the core material, which can embed or partially embed the fibers in the polymer forming material. As described herein, polymer forming material can be pushed and forced into the fiber layer to embed the fibers during a molding step, for example, a press or compression mold can push polymeric resin into the fibers to coat the fibers, fill voids in the fiber layer and contact the core material. A sufficient amount of polymer forming material can be applied to the fibers to form polymer layer that embeds the fibers and contacts the core material 12, 22 to adhere the fibers to one another and to the core. In one or more embodiments, the polymer can be formed from a curable polymer resin or composition. The composition can include a mixture of components, for example, a thermoset material, a thermoplastic material, a hardener, a catalyst, fillers, and any combination thereof. Materials can include epoxy, polyurethane, polyether ether ketone, polyethylene, or combinations thereof.

For the core sections of the covers disclosed herein, for example cores 12, 22 of the individual covers, the core material can be a plurality of open or gas-filled cells defined by cell walls. The cells can have any suitable cross-section shape (e.g., circular, hexagon, square, etc.). For example, the cores can be a honeycomb structure that includes many individual open cells side by side and arranged in the composite structures such that the cell walls are perpendicular to the longitudinal axis of the composite structure or an adjacent fiber layer. Alternatively, the cell walls can be arranged at other angles, for example, parallel or angled relative to the longitudinal axis of the composite structure. The cell walls can be made of plastic, for example, a thermoplastic or thermoset material. In one example, polypropylene or polycarbonate can be used as the material for the core and/or cell walls. The plurality of cells can be molded to form a desired shape wherein a portion of the cells are deformed under pressure, and optionally heat, to reduce the initial thickness of the core material.

The top and bottom covers 10, 20 can also be made of non-composite materials, such as a metal, an in any configuration that forms a protective shell around the battery storage area. As shown, the top or first and bottom or second covers 10, 20 are stacked, the top cover 10 overlying the bottom cover 20, to form a battery enclosure area for storing a plurality of battery units 2. In some embodiments, the top and bottom cover 10, 20 can be identical in dimensions and shape aside from an interface surface where the two covers meet, which can be mirror images of one another for forming an interlocking interface. Thickness of the bottom and top composite covers 10, 20, and those shown in the other figures, can range from about 10 to about 40 mm across the various components and regions in the covers containing a core material.

The top cover 10 includes a top section or portion that forms the central top surface of the battery enclosure. A portion of the sidewalls of the battery enclosure are formed by the sidewall section 14 of the top cover 10. In one or more embodiments, the battery enclosure 30 can be in the shape of a square or rectangular box such that the top cover 10 includes up to four sidewall sections 14 connected together and formed by core material 12 sandwiched by skins 11, 13. The bottom cover 20 includes a bottom section or portion that forms the central bottom surface of the battery enclosure. A portion of the sidewalls of the battery enclosure are formed by the sidewall section 24 of the bottom cover 20. In one or more embodiments, the bottom cover 20 includes up to four sidewall sections 24 connected together and formed by core material 22 sandwiched by skins 21, 23. Together, the sidewall sections 14, 24 of the top and bottom covers 10, 20 form the sidewalls of the battery enclosure.

Along the sidewalls of the battery enclosure, the sidewall sections 14, 24 of the top and bottom covers 10, 20 can meet, as shown, in an interlocking arrangement, in direct contact or close proximity if a seal, e.g., 36, is present therebetween, to form the battery enclosure area for storing battery units 2. The interlocking arrangement forms an interface defined in part by the shape of the perimeter surfaces for the sidewall portions of the top and bottom covers. Sidewall section 14 of the top cover 10 has a perimeter surface 15 and sidewall section 24 of the bottom cover 20 has a perimeter surface 25 that faces perimeter surface 15. The perimeter surfaces 15, 25 of the top and bottom covers 10, 20 are not entirely flat surfaces, but rather have sections that can form angles, interface angles, with respect to one another to form a non-linear interface.

As described herein, the interface can be divided into sections defined by portions of the perimeter surfaces facing or meeting one another. The interface includes at least two sections, wherein each interface section includes an interface angle formed by the facing or meeting of mirroring portions of the perimeter surfaces 15, 25 of the top and bottom covers. The at least two sections of the interface have different interface angles as compared to one another. The difference in interface angles between the first section and the second section can be any suitable degree, for example, in the range of 1° to 90°, 10° to 60°, or 20° to 50°. The interface can include more than two sections, for example, 3, 4, 5 or 6 sections. In one or more embodiments, at least two of the sections of the interface can have the same interface angle wherein the two sections having the same interface angle are not directly next to one another.

By including at least two interface sections that have different interface angles, the interface reduces the chance of material passing into or out of the battery enclosure area. For example, the various interface angles positioned in the interface forms an intricate pathway or barrier that prevents material from flowing into the battery enclosure. Thus, the interface pathway between the perimeter surfaces 15, 25 makes it difficult for debris, moisture, chemicals, liquids and the like to enter into the battery enclosure area. Preventing harmful materials from entering the battery enclosure ensures a more stable operating environment in the battery enclosure area.

As shown in FIG. 2, the interface can include a sealing material positioned between the perimeter surfaces 15, 25 of the top and bottom covers 10, 20. The sealing material can be any suitable material for forming an air-tight seal at the interface for further deterring any material from entering into or out of the battery enclosure area. For example, the sealing material can be an adhesive, a gasket, an elastomer material, a foam, and the like. The sealing material can be positioned at any point in the interface. For example, the sealing material can extend along the entire interface region or be selectively positioned in one or multiple interface sections. As shown, the sealing material 36 is positioned near the outer surface of the sidewall of the battery enclosure.

The top and bottom covers 10, 20 can be secured together by any of the means above, for instance, a fastener, adhesive, rivet, etc. In one or more embodiments, the covers 10, 20 can be secured together at or near the interface 32 area. As shown in FIG. 2, the interface 32 can extend outward from the exterior of the battery enclosure in the form of two monolithic sections, a top monolithic section 16 and a bottom monolithic section 26. The top and bottom monolithic sections, for example flanges, are free of core material and constructed from one or a combination of the respective skins 11, 13, 21, 23 of the top and bottom covers 10, 20. The monolithic sections or flanges herein can have a thickness in the range of about 1 mm to about 5 mm when devoid of core material. The monolithic sections 16, 26 form a border region, such as a flange or lip at an end area (e.g., a perimeter portion) of each cover. The monolithic section 16, 26 can be a perimeter border, or a select portion thereof, for the covers. The monolithic flange section 16 of the top cover can rest against and contact the monolithic flange section 26 of the bottom cover to fit the covers together and provide stability and structural integrity to the enclosure.

An attachment device, fastener or component 34 thereof can be joined to, or molded into or onto the monolithic sections 16, 26 to accommodate attachment or anchoring to another structure, such as the frame or body of a vehicle or adjacent composite cover in the case of a multi-piece composite battery enclosure. As shown, the monolithic sections can 16, 26 can be riveted together, or alternatively apertures in each section can be aligned to accommodate a fastener for attaching the top and covers 10, 20 together at an attachment point. The use of a fastener attachment component and the like can reduce the need for adhesives for securing the composite covers together or to other parts. In an alternative embodiment, the monolithic sections can be bound together with an adhesive material or an epoxy, which also creates an attachment point that can be used to open the battery enclosure.

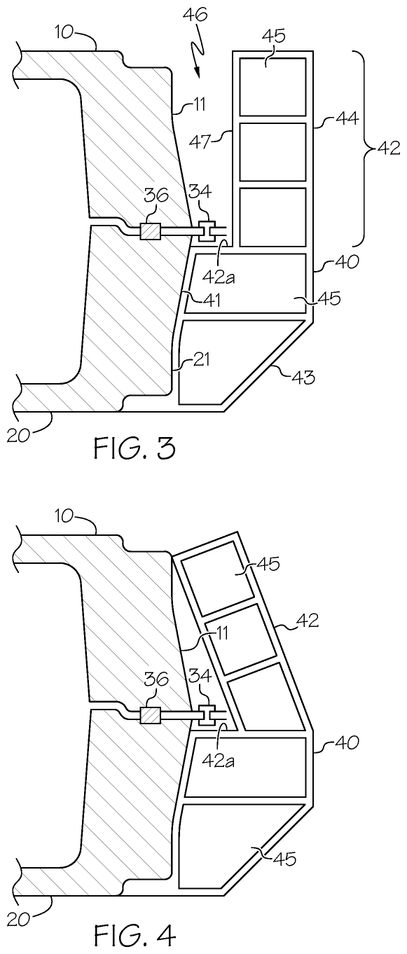

The attachment device 34 securing the covers 10, 20 together serves as a connection or attachment point as noted above. Depending on the number and arrangement of cover components, the battery enclosure can have multiple attachment points, for example, 2, 3, 4, 5 or 6 or more, that function to secure parts of the battery enclosure together, and which must be accessible to disassemble the battery enclosure or maintenance, service, inspection or for battery replacement. The battery enclosure can also have a service access component, which can include the one or more attachment points. A service access component can be also be a latch or other fastening device that provides a way to enter the battery enclosure or a portion thereof. For example, the battery enclosure can have an access panel for performing maintenance and the like, wherein the access panel, door, etc. is secured shut during operation. The service access component and attachment points are accessible on the outer surface of the battery enclosure and as shown in FIGS. 3-6, can be positioned in an open area for engagement with a user even when exterior components such as an impact barrier are arranged on the outer surface of the battery enclosure.

FIG. 3 shows an impact barrier 40 secured to the outer surface 21 of the bottom cover 20 of the battery enclosure. The impact barrier 40 has an exterior surface 41 for contacting or being positioned near or against the outer surface of the battery enclosure. The impact barrier 40 can be secured or attached to the battery enclosure by conventional methods, for example, using an adhesive or epoxy, a fastener (e.g., screw, bolt, clip), welding, a sealing material, or a combination thereof. For a chemical bond or attachment means between the impact barrier and battery enclosure, any suitable adhesive can be used, for example, an epoxy. The adhesive can be applied to an outer surface of enclosure, such as an exposed surface of fiber layer 21 as shown in FIG. 3, and an attachment surface of the impact barrier 41 designed to contact or engage with the outer surface of the battery enclosure. It is preferable that the impact barrier is permanently attached to the battery enclosure to ensure structural integrity of the battery enclosure or modular structure during use. Other fasteners or attachment fixtures can be used in place of an adhesive, for example, a screw, snap fitting, rivet, clamp, bolt or clip. Additional local inserts or onserts can be provided at attachment locations to provide increased stiffness beyond that provided by the attachment points, which are also preferably accessible through the open area formed between the deflection section 42 of the impact barrier 40 and the outer surface of the battery enclosure, for example, that formed by cover skin 11.

As shown, the impact barrier 40 has base section 43 that represents the portion of the barrier 40 that is secured to the battery enclosure. The base section 43 can be of any suitable size to provide a connection area for being secured to the battery enclosure. The impact barrier 40 includes a deflection section 42 for absorbing an external force that may contact the impact barrier. The deflection section 42 functions to absorb the external force, or a portion thereof, prior to the force being distributed to the battery enclosure to minimize the damage to the enclosure that would otherwise resulting from the external force directly contacting the battery enclosure. In some embodiments, the deflection section 42 can bend, twist, break away, crumple or otherwise deform as it absorbed an external force. To facilitate easier bending and the like, the deflection section can have a hinge point, for example 42a, that accommodates the deflection section 42 bending or deflecting from its position during normal operation of the battery enclosure.

A hinge point can be formed by arranging the deflection section 42 such that it is cantilevered from another portion of section 42, for example, the base section 43 as shown in FIG. 3. As arranged in FIG. 3, the deflection section can pivot at or near hinge point 42a as an external force contacts and outer surface 44 of the section 42. FIG. 4 illustrates an example of a deflection section 42 that has absorbed an external force and caused the section 42 to bend and deform. The deflection section 42 can bend and contact an outer surface of the battery enclosure depending on the degree of an external force. Although not shown, even after contact with a surface of the battery enclosure, the deflection section 42 can further deform, for example crumple or be crushed, while further absorbing an external force to provide additional resistance to damage to the enclosure. Preferably, the impact barrier 40 is formed from a metal material, for example aluminum, that can deform and absorb a wide variety of external forces.

In other embodiments, the deflection section 42 can also bend or be deformed in other ways that do not rely on or utilize a hinge point depending on the direction and impact position of an external force on the impact barrier 42.

The bending or deflection direction and degree of force absorption can be affected by the design of the deflection section 42. As shown in FIG. 3, the deflection section has internal hollow sections 45 that aid in the section 42 being deformed more easily as compared to a solid material. The deflection section 42 can have one or more hollow sections, for example, 2, 3, 4, 5 or 6 or more hollow sections. The hollow sections 45 can extend completely through the deflection section 42 such that a hollow section 45 form at least two openings at a surface of section 42. In other embodiments, the hollow sections 45 can be enclosed compartments in section 42. In yet another embodiment, there can be a blend of open hollow sections and enclosed compartments in the deflection section 42. In one or more embodiments, the base section 43 of the impact barrier 40 can include one or more hollow sections 45 as disclosed for the deflection section 42.

In addition to being arranged on the impact barrier 40 for absorbing an external force, the deflection section 42 as shown in FIG. 3 is arranged away from outer surface 11 of the battery enclosure to form an open area 46. The open area 46 formed between the outer surface 11 of the battery enclosure and an outer surface 47 of section 42 includes attachment point 34 that secures cover 10, 20. The open area 46 is further accessible to a user so an attachment point or service access component can be reached during a maintenance or inspection situation, for example, the open area 46 can be sized and arranged to accommodate a tool or other apparatus that is needed to remove a fastener or the like to disassemble the battery enclosure or a portion thereof. To facilitate tools or similar components required to detach or unhinge a fastener or the like at an attachment point or service access component, the opening 46 can be sized and configured as desired by changing the shape and dimensions of the deflection section 42, and if needed, the base section 43.

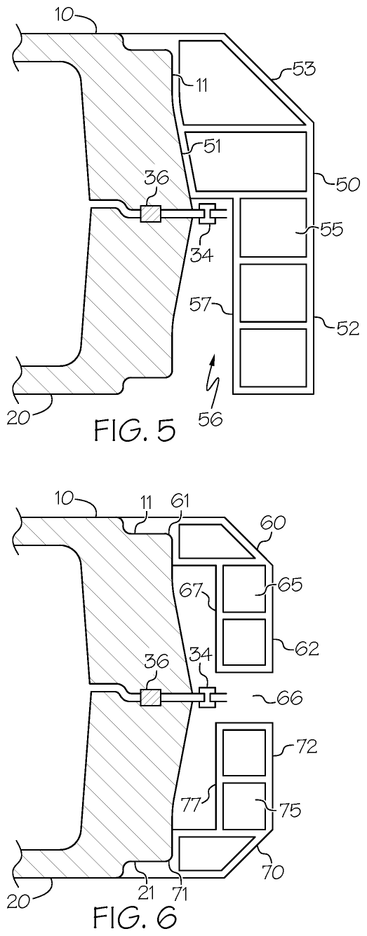

In one or more embodiments, the impact barrier can have alternate shapes as that shown in FIG. 3. For example, FIG. 5 shows an impact barrier 50 having a surface 51 of base section 53 secured to an outer surface 11 of cover 10 of a battery enclosure. The deflection section 52 of the impact barrier 50 extends downward from base section 53 in an arrangement where it is spaced apart from an outer surface 21 of the enclosure. An open area 56 is formed between the outer surface 21 of the bottom cover 20 of the battery enclosure and an outer surface 57 of section 52. The open area 56 includes attachment point 34 that secures cover 10, 20 and area 56 is further accessible to a user so an attachment point or service access component can be reached during a maintenance or inspection situation. Area 56 can be sized and arranged to accommodate a tool or other apparatus that is needed to remove a fastener or the like to disassemble the battery enclosure or a portion thereof. To facilitate tools or similar components required to detach or unhinge a fastener or the like at an attachment point or service access component, the opening 56 can be sized and configured as desired by changing the shape and dimensions of the deflection section 52, and if needed, the base section 53. Impact barrier 50 can also include hollow sections 55 as described for the impact barrier of FIG. 3.

The configuration shown in FIG. 5 can extend around the entire perimeter of a battery enclosure, or in the alternative, a plurality of impact barriers can be mounted or secured to the perimeter surface of an enclosure to provide protection from external forces or damage threats. In other embodiments, select areas of a battery enclosure can be protected with one or more impact barriers in areas that are prone to being damaged. Likewise, the open areas formed by deflection sections of an impact barrier can be positioned to best accommodate access to attachment points and protection of equipment. For example, the impact barrier 50 of FIG. 5 has a deflection section 52 facing downward, which can function to keep debris, water and other harmful environmental compounds away from areas of the battery enclosure that are opened and closed on a maintenance schedule or that may contain cracks or small openings that expose internal components of the enclosure.

FIG. 6 shows another embodiment design for an impact barrier. The battery enclosure has a first impact barrier 60 having a surface 61 of a base section secured to an outer surface 11 of cover 10 of a battery enclosure. The deflection section 62 of the impact barrier 60 extends downward from the base section in an arrangement where it is spaced apart from an outer surface 11 of the enclosure below where the base section is attached to surface 11. The battery enclosure has a second impact barrier 70 having a surface 71 of a base section secured to an outer surface 21 of cover 20 of a battery enclosure. The deflection section 72 of the impact barrier 70 extends upward from the base section in an arrangement where it is spaced apart from an outer surface 21 of the enclosure below where the base section is attached to surface 21.

The end faces of the deflection sections 62, 72 face one another but do not contact each other. The end faces form an opening 66 that exposes attachment device 34 securing the covers 10, 20 together that serves as a connection or attachment point. The open area 66 is further accessible to a user so an attachment point or service access component can be reached during a maintenance or inspection situation, for example, the open area 66 can be sized and arranged to accommodate a tool or other apparatus that is needed to remove a fastener or the like to disassemble the battery enclosure or a portion thereof. The open area 66 can be sized and configured as needed, for example, by changing the shape and dimensions of sections 62, 72, to facilitate tools or similar components required to detach or unhinge a fastener or the like at an attachment point or service access component.

Surfaces 67 and 77 of the deflection sections 62, 72 of the impact barriers 60, 70 are also respectively spaced apart from surfaces 11 and 21 of the battery enclosure to form additional open area in communication with area 66. These additional openings permit the deflection sections 62, 72 to bend inward when contacted by an external force for absorbing and deflecting the force from the battery enclosure and thereby reducing potential damage. Alternatively, open area 66 could be covered with a thin material to prevent debris, moisture, etc. from collecting around the outer surface of the enclosure and attachment point. Any thin material can be selected to not interfere with the bending and deformation of the deflection sections 62, 72 as they are intended and designed to operate. Material can be removed and replaced or re-attached after any access by use to the battery enclosure during a maintenance or inspection situation.

The first and second impact barriers 60, 70 can have similar design characteristics and components as impact barriers 40, 50 above. For example, impact barriers 60, 70 can also include hollow sections 65, 75 as described for the impact barrier of FIG. 3. Similarly, impact barriers 60, 70 can be attached to an outer surface of a battery enclosure, preferably in a permanent or semi-permanent manner, by methods and devices discussed above for impact barriers 40 and 50.

While various aspects and embodiments of the compositions and methods have been disclosed herein, other aspects and embodiments will be apparent to those skilled in the art. The various aspects and embodiments disclosed herein are for purposes of illustration and are not intended to be limiting, with the true scope and spirit being indicated by the claims.

1. A battery enclosure comprising:
a. an outer surface of the battery enclosure;
b. a first cover component and a second cover component forming an exterior portion of the outer surface of the battery enclosure;
c. an impact barrier positioned on the outer surface of the battery enclosure, the impact barrier comprising a deflection section arranged away from the outer surface of the battery enclosure.

2. The battery enclosure of claim 1, wherein the impact barrier being made of a material selected from the group consisting of metal alloys, carbon steel, aluminum, stainless steel, carbon fiber, fiber glass and combinations thereof.

3. The battery enclosure of claim 1, wherein the impact barrier comprises a plurality of hollow sections.

4. The battery enclosure of claim 1, wherein an open area is formed between the outer surface of the battery enclosure and the deflection section of the impact barrier.

5. The battery enclosure of claim 1, further comprising a second impact barrier positioned on the outer surface of the battery enclosure.

6. The battery enclosure of claim 1, wherein the impact barrier further comprises a base section, the base section being secured to the outer surface of the battery enclosure.

7. The battery enclosure of claim 6, the deflection section of the impact barrier extending from the base section.

8. The battery enclosure of claim 1, wherein the first cover component and the second cover component are secured together at an attachment point.

9. The battery enclosure of claim 8, wherein the attachment point is accessible in an open area formed between the outer surface of the battery enclosure and the deflection section of the impact barrier.

10. The battery enclosure of claim 1, wherein a service access component is arranged on the outer surface of the battery enclosure.

11. The battery enclosure of claim 10, wherein the service access component is positioned in an open area formed between the outer surface of the battery enclosure and the deflection section of the impact barrier such that the service access component is accessible through the open area.

12. The battery enclosure of claim 11, wherein the service access component comprises a fastening device.

13. The battery enclosure of claim 12, wherein the fastening device secures the first cover component and the second cover component together that form a portion of the battery enclosure.

14. The battery enclosure of claim 11, wherein the service access component permits access to the battery storage space inside the battery enclosure.

15. The battery enclosure of claim 6, wherein the deflection section of the impact barrier is cantilevered from a base section of the impact barrier.
